(19) United States
(12) Patent Application Publication
(10) Pub. No.: US 2018/0081443 A1
(43) Pub. Date: Mar. 22, 2018

(54) DISPLAY CONTROL APPARATUS, DISPLAY CONTROL SYSTEM, AND DISPLAY CONTROL METHOD

(71) Applicant: Fujitsu Ten Limited, Kobe-shi (JP)

(72) Inventor: Hironobu MOROFUJI, Kobe-shi (JP)

(73) Assignee: FUJITSU TEN LIMITED, Kobe-shi (JP)

(21) Appl. No.: 15/705,522

(22) Filed: Sep. 15, 2017

(30) Foreign Application Priority Data
Sep. 21, 2016 (JP) 2016-184006

(51) Int. Cl. G06F 3/01; G06F 3/0488

(52) U.S. Cl. CPC G06F 3/016; G06F 3/04883

(57) ABSTRACT

To provide a technique for giving a tactual sensation such that a user can clearly perceive that an operation position has reached a predetermined position. A display control unit that causes the display unit to display the object, an operation acceptance unit that accepts an operation for the object on the display surface on the basis of a detection result from a detection unit that detects contact with the operation surface, and a vibration control unit that controls a vibration unit that vibrates the operation surface if the operation accepted by the operation acceptance unit is a slide operation from an outside of a predetermined range defined on the display surface to an inside of the predetermined range and vibrates the operation surface in a predetermined vibrational state when the slide operation reaches the inside of the predetermined range.

### CROSS-REFERENCE TO RELATED APPLICATION

The present application claims priority to Japanese Patent Application No. 2016-184006, filed Sep. 21, 2016, the entire contents of which are incorporated herein by reference.

### TECHNICAL FIELD

The present invention relates to a display control apparatus, a display control system, and a display control method.

### BACKGROUND ART

There has conventionally been known an apparatus which includes a touch panel placed on a display device, such as a liquid crystal display (LCD), and detects coordinates of a contact position with the touch panel and accepts the coordinates as operation information for the object when a user performs an operation for an object, such as an icon or a menu, displayed on the display device by touching a display surface (an operation surface). There has been also known an apparatus which includes a touch-pad separately from a display device, and detects coordinates of a contact position, moves a cursor on the display device in accordance with an input operation, and selects an object as a target of operation with the cursor when a user touches the touch-pad and performs the input operation.

### CITATION LIST

### Patent Document

[Patent document 1] Japanese Patent Laid-Open No. 2010-9321

### SUMMARY OF THE INVENTION

### Problems to be Solved by the Invention

If a user performs an input operation on a vehicle-mounted apparatus while driving a vehicle, the user may search for an operation button not just visually but also tactually and perform an operation. However, in each of the apparatuses, to which input is done through a touch panel or a touch-pad, an input surface is often an even plane surface, and a user is unable to recognize an object (a target of operation), such as a button with a tactual sensation.

For this reason, an input apparatus is proposed which has a plurality of operation button regions assigned on a detection surface of touch detection means that accepts user input, and vibrates itself in accordance with a user's touch on an operation button region to allow the user to perceive the presence of the operation button region through the vibration (Patent document 1).

In the case where an apparatus is vibrated depending on whether a user is in touch with an operation button region, a user judges, on the basis of the presence or absence of vibration, whether an operation button region has been reached. This case is significantly different from a conventional case where a physical button is tactually searched for and suffers from the problem of the inability at intuitive judgment.

In a case where an apparatus is vibrated, a user easily perceives vibration if the apparatus is a portable apparatus, such as a smartphone. If the apparatus is a stationary apparatus, the user has difficulty in perceiving vibration of the apparatus. In an environment in which running-induced vibration occurs, such as an environment for a vehicle-mounted apparatus, distinction between vibration felt at a touch on an operation button region and running-induced vibration may be difficult.

Under the circumstances, the present invention has as its object to provide a technique for giving a tactual sensation such that a user can clearly perceive that an operation position has reached a predetermined position.

### Means for Solving the Problems

In order to solve the above-described problems, a display control apparatus according to the present invention is a display control apparatus for displaying an object as a target of operation on a display surface of a display unit and accepting a user operation for an operation surface associated with the display surface, including a display control unit that causes the display unit to display the object, an operation acceptance unit that accepts an operation for the object on the display surface on the basis of a detection result from a detection unit that detects a contact with the operation surface, and a vibration control unit that controls a vibration unit that vibrates the operation surface if the operation accepted by the operation acceptance unit is a slide operation from an outside of a predetermined range defined on the display surface to an inside of the predetermined range and causes the operation surface to vibrate in a predetermined vibrational state when the slide operation reaches the inside of the predetermined range.

### Effects of the Invention

The present invention allows provision of a technique for giving a tactual sensation such that a user can clearly perceive that an operation position has reached a predetermined position.

### BRIEF DESCRIPTION OF THE DRAWINGS

FIG. 1 is a view illustrating an example of the configuration of a display control system according to the present embodiment.

FIG. 2 is a functional block diagram of the display control system according to the present embodiment.

FIG. 3 is a schematic view of a touch-pad.

FIGS. 4A and 4B are views for explaining a change in a tactual sensation caused by vibration of an operation surface.

FIGS. 5A to 5C are views each illustrating an example where objects as targets of operation are displayed on a display unit.

FIG. 6 is an explanatory chart for explaining a change in the amount of vibration generated when the operation surface is vibrated in accordance with a slide operation.

FIG. 7 is an explanatory for explaining a change in the amount of vibration when the operation surface is vibrated in accordance with a slide operation.

FIG. 8 is a view illustrating an example where a cursor is operated from the inside of a predetermined range to the outside.

FIG. 9 is a diagram illustrating an example of the hardware configuration of a display control apparatus.

FIG. 10 is a chart illustrating an example of the procedure for a display control method to be executed by the display control apparatus.

FIGS. 11A and 11B are views each illustrating an example where objects as targets of operation are displayed on a display unit.

### DESCRIPTION OF EMBODIMENTS

Embodiments of the present invention will be described below with reference to the drawings. The configurations of the embodiments below are merely illustrative, and the present invention is not limited to the configurations of the embodiments.

### First Embodiment

### <System Configuration>

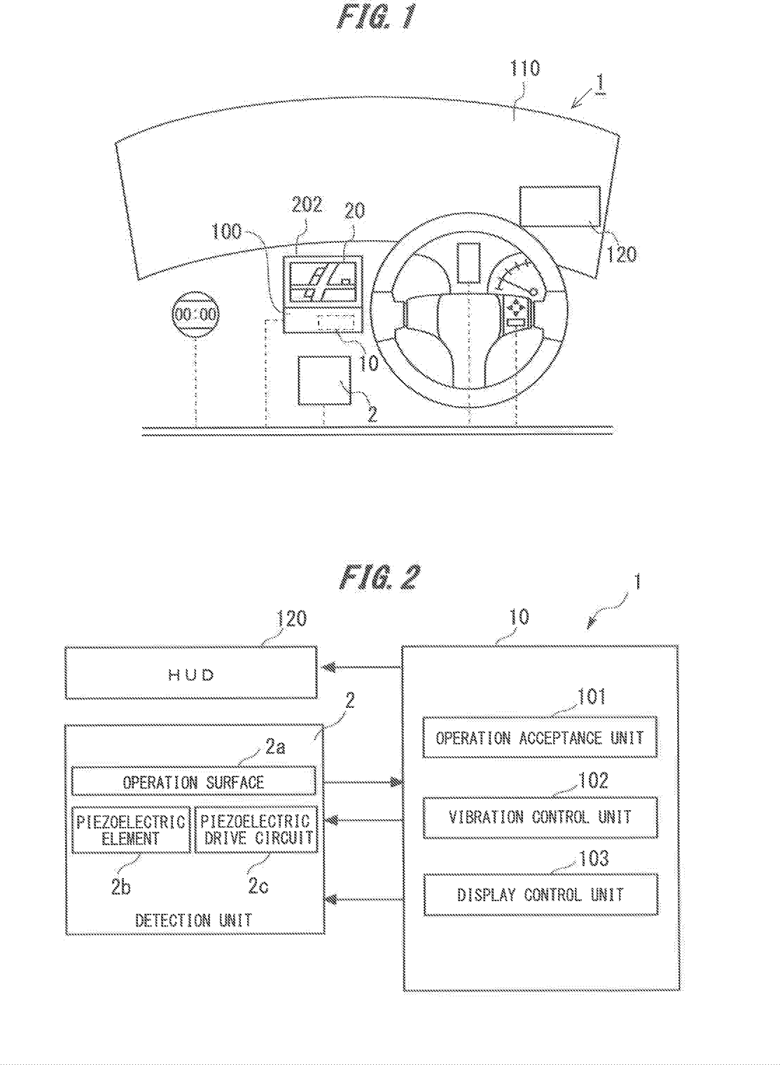

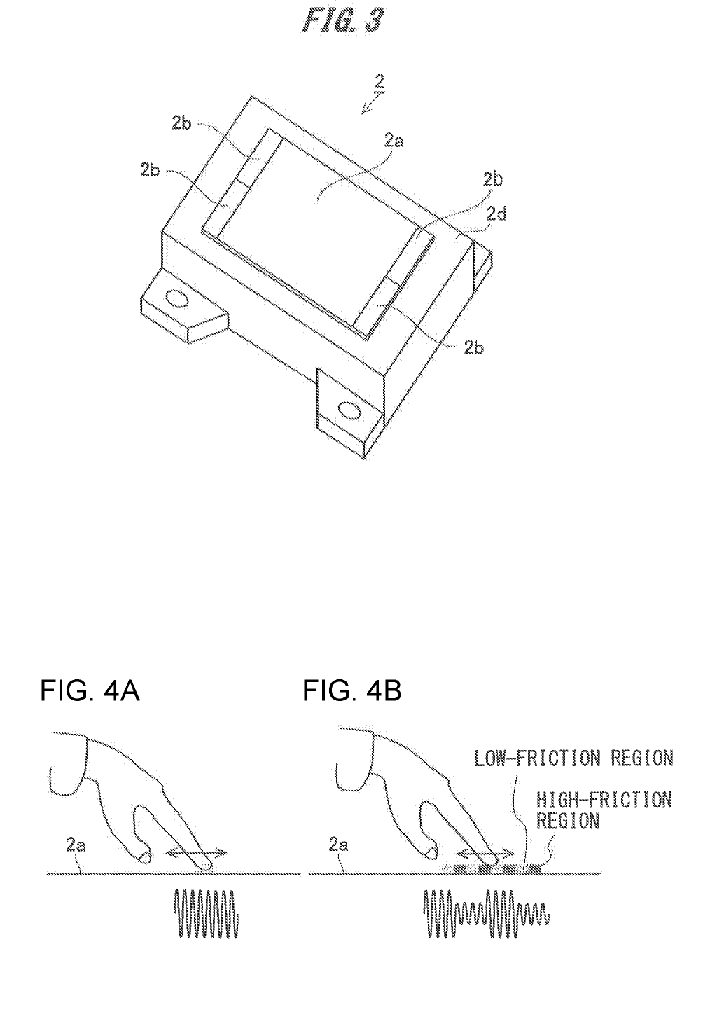

FIG. 1 is a view illustrating an example of the configuration of a display control system according to the present embodiment. FIG. 2 is a functional block diagram of the display control system according to the present embodiment. FIG. 3 is a schematic view of a touch-pad 2. A display control system 1 illustrated in FIGS. 1 and 2 includes audio visual navigation combination electronic equipment (hereinafter also referred to as an AVN machine) 100 which is mounted on a vehicle, a head-up display (HUD) 120 on a vehicle interior side of a windshield 110, onto which content to be displayed is to be projected, and the touch-pad 2, through which an operation for an object displayed on the HUD 120 is input. The AVN machine 100 includes a display control apparatus 10 according to the present embodiment.

Information provided from the AVN machine 100 or an ECU (not illustrated) of the vehicle is displayed on the HUD 120. For example, an object as a target of operation on the touch-pad 2, such as an icon, an option of a menu or the like, or a cursor for selecting an icon or an option, is displayed.

The touch-pad 2 is provided separately from the HUD 120 and the AVN machine 100 and is arranged at, for example, a center console. Note that the touch-pad 2 is not limited to the center console and may be provided at any other position, such as a shift knob or steering, as long as a user can operate the touch-pad 2.

The touch-pad 2 is an input device (detection unit) that detects, as operation information, a contact position of a finger or the like of a user in contact with an operation surface 2a provided at a top portion of a housing 2d or a change in the contact position. The contact position of the finger or the like of the user in contact with the operation surface 2a is input as two-dimensional coordinates (X,Y) in a coordinate system having the upper left corner of the touch-pad 2 as an origin, a horizontal direction as an X-axis, and a vertical direction as a Y-axis to the touch-pad 2. Coordinates of the contact position detected by the touch-pad 2 are input to the display control apparatus 10 at fixed periodic intervals of, for example, 10 ms. For this reason, if the user performs a slide operation so as to trace the operation surface and changes the contact position, the touch-pad 2 sequentially inputs coordinates of the contact position to the display control apparatus 10. Along with a change in coordinates of the contact position, the display control apparatus 10 accepts, as operation information, the direction of the slide operation and the amount of sliding (the amount of movement). For example, the display control apparatus 10 associates a display surface of the HUD 120 with the operation surface 2a of the touch-pad 2, and moves the position of a cursor displayed on the HUD 120 if a slide operation is performed for the operation surface 2a. In this manner, the touch-pad 2 functions as a pointing device which designates the position of an operation for an object displayed on the HUD 120. The touch-pad 2 may detect an operation, such as a press or a tap, for the operation surface 2a and input the operation as, for example, an operation (hereinafter also referred to as a selection operation) of selecting an object at a position designated with the cursor to the display control apparatus 10. Note that a selection operation is not limited to an operation for the operation surface 2a, a physical operation button may be provided in the vicinity of the operation surface 2a, and that information indicating that the operation button is pushed may be input as a selection operation to the display control apparatus 10.

The touch-pad 2 is also a device which vibrates the operation surface and gives a tactual sensation, such as a rough sensation or a smooth sensation, to a finger or the like of a user in contact. The touch-pad 2 includes piezoelectric elements, such as piezoelectric elements 2b, at portions (e.g., four corners) of the operation surface and includes a piezoelectric drive circuit 2c for applying a predetermined voltage value to the piezoelectric element 2b inside the housing 2d. The operation surface 2a and the piezoelectric elements 2b are a form of a vibration unit according to the present embodiment. For example, the piezoelectric drive circuit 2c supplies a driving current modulated so as to cause the piezoelectric elements 2b to vibrate at a frequency Fo which is a frequency outside a human audible range and resonates the operation surface 2a to the piezoelectric elements 2b.

For example, if the operation surface 2a is vibrated at a low frequency, a user in contact with the operation surface 2a can sense the operation surface 2a vibrating. If the frequency for vibration is increased to above a predetermined frequency, the user has difficulty in sensing vibration even when the user is in contact with the operation surface 2a. If the user touches the operation surface 2a and performs a slide operation while vibrating the operation surface 2a at the high frequency, a sensation of resistance at the time of sliding can be reduced. That is, a smooth sensation can be given to the user that performs the slide operation. The present embodiment is set so as to resonate the operation surface 2a at the high frequency Fo as described above by driving the piezoelectric elements 2b with the piezoelectric drive circuit 2c and give a smooth sensation to the user that performs a slide operation on the operation surface 2a.

The amplitude of vibration may be changed by modulating a voltage at the time of driving the piezoelectric elements 2b with the piezoelectric drive circuit 2c, and a tactual sensation given to a user may be changed. For example, if the operation surface 2a is vibrated at the frequency Fo with a fixed amplitude, as illustrated in FIG. 4A, a smooth sensation with less frictional resistance can be given to the user that performs a slide operation on the operation surface 2a, as described above. On the other hand, if amplitude is intermittently changed at the frequency Fo, a low-frictional-resistance portion and a high-frictional-resistance portion appear intermittently for a fingertip of the user that performs a slide operation on the operation surface 2a, and a rough sensation can be given, as illustrated in FIG. 4B.

<Display and Tactual Sensation Control>

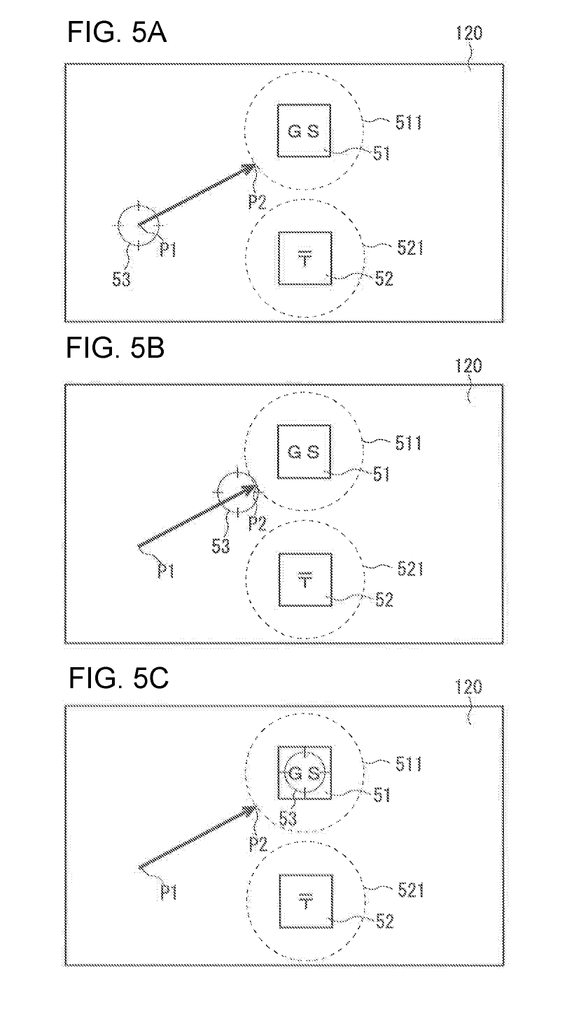

FIGS. 5A, 5B, and 5C are views each illustrating an example where objects as targets of operation are displayed on a display unit (the HUD 120). As illustrated in, for example, FIGS. 5A to 5C, the display control apparatus 10 according to the present embodiment displays a plurality of icons 51 and 52 and a cursor 53 as objects as targets of operation on the display surface of the HUD 120. Predetermined ranges 511 and 521 are defined at positions including the icons 51 and 52. The predetermined ranges 511 and 512 extend from centers of the icons 51 and 52 over a predetermined distance. When the cursor 53 reaches the inside of the predetermined range 511 or 521, the icon 51 or 52 is regarded as a target of selection, and control that draws the cursor 53 into the icon 51 or 52 is executed.

When a slide operation is performed for the operation surface 2a of the touch-pad 2, the display control apparatus 10 moves the cursor 53 in accordance with the direction of the slide operation and the amount of sliding. For example, if the cursor 53 is moved toward the icon 51 and reaches the inside of the predetermined range 511, as illustrated in FIG. 5A, the display control apparatus 10 vibrates the operation surface 2a of the touch-pad 2 in a predetermined vibrational state and stops the vibration after a predetermined time (e.g., 0.1 s). This reduces a sensation of resistance of a finger performing the slide operation on the operation surface of the touch-pad 2 for a moment, slips the finger, restores the sensation of resistance, and stops the finger. The cursor 53 displayed on the HUD 120 is moved onto the icon 51 at this time, as illustrated in FIG. 5C. That is, a display position of the cursor 53 is changed to a position at which a center of the cursor 53 coincides with the center of the icon 51. As described above, the cursor 53 is moved so as to be drawn into the icon 51, and the sensation that a fingertip is slipped for a moment is given at the moment of the movement. This gives a user the illusion that the finger is drawn onto the icon 51.

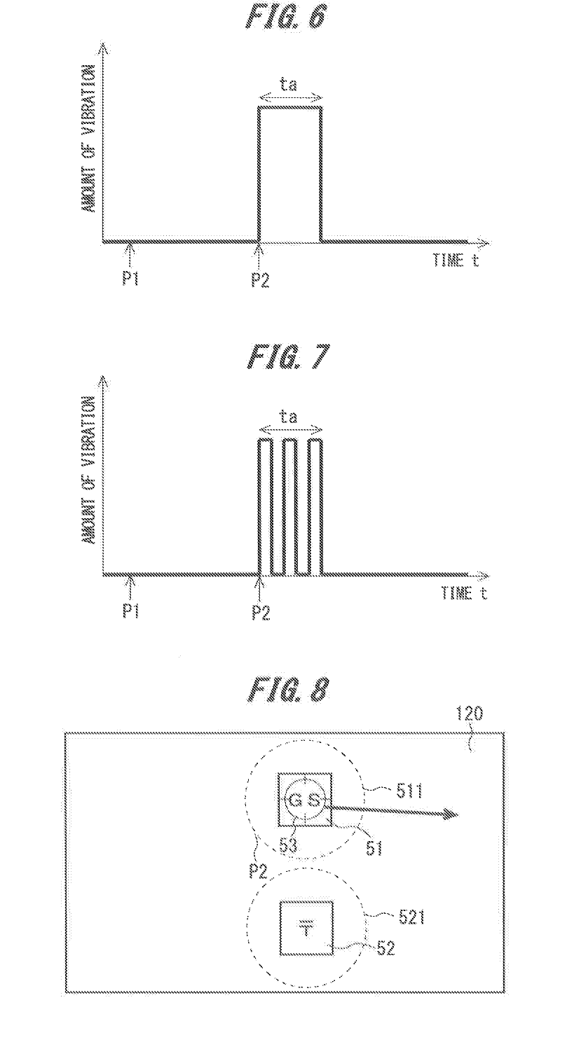

FIG. 6 is an explanatory chart for explaining a change in the amount of vibration generated when the operation surface 2a is vibrated in accordance with a slide operation. In FIG. 6, the ordinate represents the magnitude of the amount of vibration (amplitude) while the abscissa represents time.

Until the cursor 53 reaches the predetermined range 511 through a slide operation (e.g., from a start point P1 for the slide operation to a time point P2 when the cursor 53 reaches the inside of the predetermined range 511 in FIG. 5A), the operation surface 2a is not vibrated. From the time point P2 when the cursor 53 reaches the inside of the predetermined range 511 to after a predetermined time ta, the operation surface 2a is vibrated in the predetermined vibrational state. For example, assume that the resonance frequency Fo of the operation surface 2a is 20 to 40 kHz and that a drive voltage is 20 to 40 Vpp. Also, assume that the predetermined time ta is 0.05 to 0.5 s.

After a lapse of the predetermined time ta, the operation surface 2a is restored to a state before P2 (e.g., a non-vibrating state).

Note that although a smooth sensation is given to a user in the example in FIG. 6 when the slide operation reaches the predetermined range 511, the present invention is not limited to this. Any other sensation may be given. For example, as illustrated in FIG. 7, the operation surface 2a may be vibrated intermittently to give a rough sensation from the time point P2 when the cursor 53 reaches the predetermined range 511 through a slide operation to after the predetermined time ta. For example, different vibrational states may be defined for the icons 51 and 52. When a slide operation reaches the predetermined range 511 or 521 of the icon 51 or 52, the operation surface 2a may be vibrated in a predetermined one of the different vibrational states, and different sensations may be given for the icons 51 and 52 to a user. With this configuration, the user can intuitively perceive the type of the icon 51 or 52, on which the cursor is placed, by a difference in tactual sensation.

FIG. 8 is a view illustrating an example where the cursor 53 is operated from the inside of the predetermined range 511 to the outside. When a slide operation is performed for the operation surface 2a of the touch-pad 2, the cursor 53 located on the inside of the predetermined range 511 is moved toward the outside of the predetermined range 511, as illustrated in FIG. 8. When the cursor 53 reaches the outside of the predetermined range 511, the display control apparatus 10 vibrates the operation surface 2a of the touch-pad 2 in a predetermined vibrational state and stops the vibration after the predetermined time ta. This reduces a sensation of resistance of a finger performing the slide operation on the operation surface of the touch-pad 2 for a moment, slips the finger, restores the sensation of resistance, and stops the finger. In this manner, the sensation that the finger has come out of the icon 51 is given to a user.

<Display Control Apparatus Configuration>

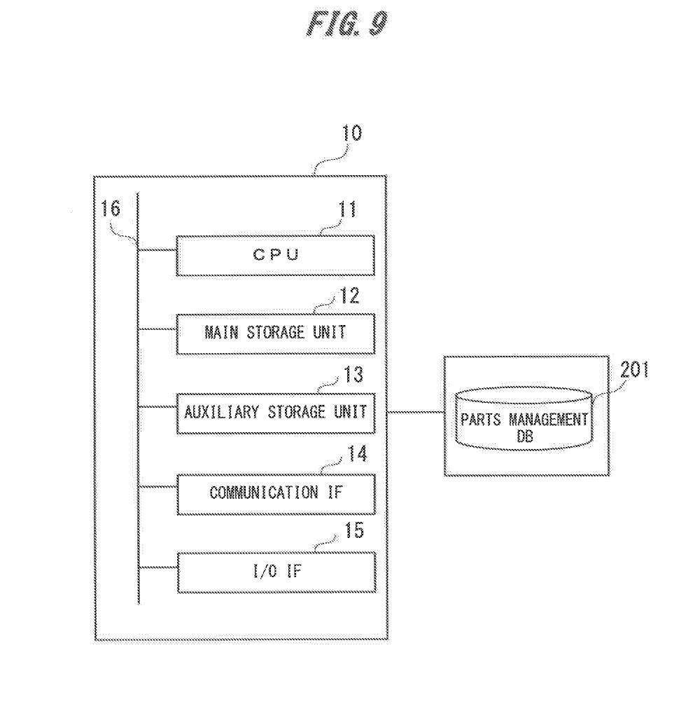

FIG. 9 is a diagram illustrating an example of the hardware configuration of the display control apparatus 10. As illustrated in FIG. 9, the display control apparatus 10 has a central processing unit (CPU) 11, a main storage unit 12, an auxiliary storage unit 13, a communication interface (IF) 14, and an I/O IF 15 which are connected to one another via a connection bus 16. The CPU 11 is a central processing arithmetic apparatus that controls the entire display control apparatus 10. The CPU 11 is also called a processor. Note that the CPU 11 is not limited to a single processor and may have a multiprocessor configuration. The single CPU 11 connected by a single socket may have a multicore configuration. The CPU 11 provides a function which suits a predetermined purpose by loading a program stored in the auxiliary storage unit 13 onto a work region of the main storage unit 12 in executable form and controlling peripheral equipment through execution of the program.

The main storage unit 12 is a storage medium, in which the CPU 11 caches a program or data and in which a work region is provided. The main storage unit 12 includes, for example, a flash memory, a random access memory (RAM), and a read only memory (ROM). The auxiliary storage unit 13 is a storage medium which stores a program to be executed by the CPU 11, operation setting information, and the like. The auxiliary storage unit 13 is, for example, a hard-disk drive (HDD), a solid state drive (SSD), an erasable programmable ROM (EPROM), a flash memory, a USB memory, a secure digital (SD) memory card, or the like. The communication IF 14 is an interface with a network or the like connected to the display control apparatus 10. The I/O IF 15 is an interface for data input and output from and to a sensor or equipment connected to the display control apparatus 10. In the display control system 1, data I/O control of the touch-pad 2 is performed via the I/O IF 15. Note that the number of each of the constituent elements may be two or more or some of the constituent elements may be omitted. The constituent elements may be included as constituent elements of the AVN machine.

In the display control apparatus 10, execution of a program by the CPU 11 provides the processing units of an operation acceptance unit 101, a vibration control unit 102, and a display control unit 103 illustrated in FIG. 1. Note that processes of at least some of the processing units may each be provided by a digital signal processor (DSP), an application specific integrated circuit (ASIC), or the like. At least some of the processing units may each be a dedicated large scale integration (LSI), such as a field-programmable gate array (FPGA), or any other digital circuit. An analog circuit may be included in each of at least some of the processing units. The display control apparatus 10 includes a parts management DB 201 in the auxiliary storage unit 13, as a storage destination for data to be referred to or managed by the processing units.

The operation acceptance unit 101 in accepts coordinates of a finger contact position detected via the touch-pad 2. The operation acceptance unit 101 accepts coordinates of the contact position at fixed periodic intervals of, for example, 10 ms. The operation acceptance unit 101 temporarily stores the coordinates of the contact position in a predetermined region of the main storage unit 12. A change in coordinates of the contact position accepted at the fixed periodic intervals is a time-series trajectory which accompanies a movement operation on the touch-pad 2. The operation acceptance unit 101 passes acquired coordinates of the contact position to the vibration control unit 102 and the display control unit 103.

If an operation based on coordinates of contact positions passed from the operation acceptance unit 101 and a temporal change in coordinates is a slide operation from the outside of a predetermined range defined on the display surface of the HUD 120 to the inside of the predetermined range, the vibration control unit 102 controls the piezoelectric drive circuit 2c. When the slide operation reaches the inside of the predetermined range, the vibration control unit 102 vibrates the operation surface 2a in a predetermined vibrational state for a predetermined time. If the operation passed from the operation acceptance unit 101 is a slide operation from the inside of the predetermined range defined on the display surface of the HUD 120 to the outside, the vibration control unit 102 controls the piezoelectric drive circuit 2c. When the slide operation reaches the outside of the predetermined range, the vibration control unit 102 vibrates the operation surface 2a in a predetermined vibrational state for a predetermined time.

The display control unit 103 controls display states of, for example, the cursor 53 and the icons 51 and 52 described with reference to FIGS. 5A to 5C and 8 on the basis of coordinates of a contact position passed from the operation acceptance unit 101 and a temporal change in coordinates. Note that a display state of picture content or an object (GUI part) is changed by referring to, for example, the parts management DB 201. Picture information of an object, such as a selection menu or an icon, serving as a target of a selection operation, coordinate information indicating a predetermined range within which the cursor 53 is regarded as being located on the object, information indicating a vibrational state set for each object serving as a target of a selection operation, and the like are associated and stored in the parts management DB 201 included in the auxiliary storage unit 13.

The display control unit 103 moves and displays the cursor 53 on the basis of coordinates of contact positions passed from the operation acceptance unit 101 and a temporal change in coordinates.

<Processing Flow>

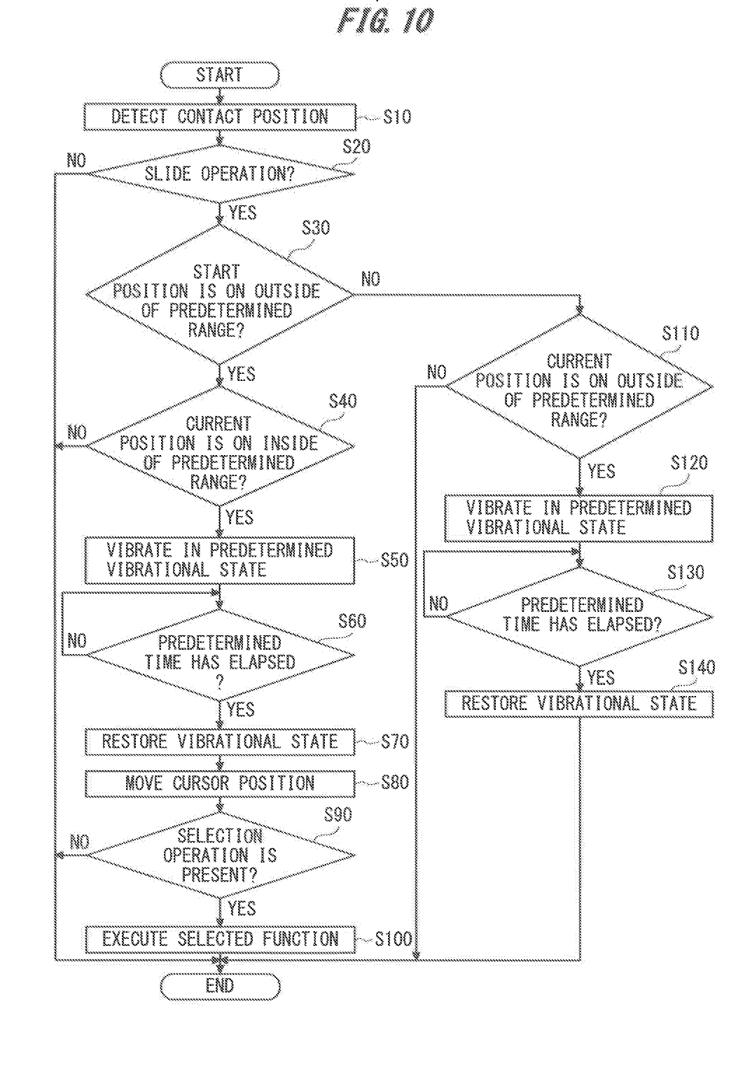

A display and tactual sensation control process according to the present embodiment will be described below with reference to FIG. 10. FIG. 10 is chart illustrating an example of a procedure for a display control method to be executed by the display control apparatus 10. The display control apparatus 10 according to the present embodiment provides the control process illustrated in FIG. 10 by, for example, the CPU 11 or the like reading out and executing various programs and various data stored in the auxiliary storage unit 13.

The display control apparatus 10 starts the process in FIG. 10 periodically or when a contact is detected by the touch-pad 2. The display control apparatus 10 accepts, as operation information, coordinates (X1, Y1) of a contact position detected via the touch-pad 2 at fixed periodic intervals of 10 ms (S10). The display control apparatus 10 temporarily stores a change in operation information from the current moment to a predetermined time before in the predetermined region of the main storage unit 12.

The display control apparatus 10 judges whether an operation accepted in step S10 is a slide operation, i.e., whether coordinates have changed continuously so as to trace the operation surface (step S20). The display control apparatus 10 ends the process in FIG. 10 if the accepted operation is not a slide operation (NO in step S20) and judges whether a movement start point of the cursor 53 moved through the slide operation is on the outside of a predetermined range (e.g., 511 or 521 in FIG. 5) (step S30) if the accepted operation is a slide operation (YES in step S20).

If the movement start position is on the outside of the predetermined range (YES in step S30), the display control apparatus 10 judges whether a current position of the cursor 53 has reached the inside of the predetermined range (step S40). If the position of the cursor 53 has reached the inside of the predetermined range (YES in step S40), the display control apparatus 10 controls the piezoelectric drive circuit 2c to vibrate the operation surface 2a in a predetermined vibrational state. At this time, the display control apparatus 10 refers to the parts management DB 201 and identifies an object (icon), to which the predetermined range is assigned, and vibrates the operation surface 2a on the basis of a vibrational state set for the object (step S50). This reduces friction of a finger performing the slide operation on the operation surface.

The display control apparatus 10 judges whether a predetermined time has elapsed from the start of the vibration in step S50 (step S60). If the predetermined time has elapsed (YES in step S60), the display control apparatus 10 restores the operation surface 2a to a state before the start of the vibration in step S50 (step S70). For example, if the operation surface 2a before step S50 is in a non-vibrating state, the display control apparatus 10 stops the vibration of the operation surface 2a. This increases the friction of the finger performing the slide operation on the operation surface.

The display control apparatus 10 moves the display position of the cursor 53 displayed on the HUD 120 to a predetermined position (step S80). For example, the display control apparatus 10 moves the display position of the cursor 53 onto the icon 51, as illustrated in FIG. 5C. By the movement, i.e., by changing the display position of the cursor 53 to a position at which the center of the cursor 53 coincides with the center of the icon 51, a user is given the illusion that the finger is drawn onto the icon 51.

The display control apparatus 10 judges whether a selection operation is performed for the icon 51 (step S90). If such a selection operation is performed (YES in step S90), the display control apparatus 10 executes a function assigned to the icon (an object as a target of selection) (step S100).

On the other hand, if the start point of the slide operation is on the inside of the predetermined range in step S30 (NO in step S30), the display control apparatus 10 judges whether the current position of the cursor 53 has reached the outside of the predetermined range (step S110). If the position of the cursor 53 has reached the outside of the predetermined range (YES in step S110), the display control apparatus 10 controls the piezoelectric drive circuit 2c to vibrate the operation surface 2a in a predetermined vibrational state (step S120). At this time, the display control apparatus 10 refers to the parts management DB 201 and identifies the object (icon), to which the predetermined range is assigned, and vibrates the operation surface 2a on the basis of a vibrational state set for the object.

The display control apparatus 10 judges whether a predetermined time has elapsed from the start of the vibration in step S120 (step S130). If the predetermined time has elapsed (YES in step S130), the display control apparatus 10 restores the operation surface 2a to a state before the start of the vibration in step S120 (step S140). For example, if the operation surface 2a before step S120 is in a non-vibrating state, the display control apparatus 10 stops the vibration of the operation surface 2a. Note that, if vibration is started in step S120 to make the finger slip easily, the finger may make a big movement to excessively move the cursor 53. For this reason, control may be pertained such that an operation performed for the operation surface 2a until the vibrational state is restored in step S140 may be nullified so as not to be reflected in cursor movement.

If an operation of moving the cursor 53 from the inside of the predetermined range to the outside is performed, as described above, the display control apparatus 10 can clearly indicate to the user that the finger has come out of the predetermined range by giving the sensation that a fingertip slips for a moment.

### <Operation and Effects of Embodiment>

As described above, a display control apparatus according to the present embodiment controls the piezoelectric drive circuit 2c to vibrate the operation surface 2a in a predetermined vibrational state if a slide operation from an outside of a predetermined range defined on a display surface to an inside of the predetermined range is performed.

With this configuration, it is possible to suggest, through a change in tactual sensation, to a user that an operation position has reached the inside of the predetermined range such that the user can clearly perceive the fact. As described above, the user can perceive, by a change in a tactual sensation of a fingertip, that the operation position has reached the inside of the predetermined range at the time of touching the operation surface 2a of the touch-pad 2 and performing a slide operation while checking an operation direction and the amount of operation with the fingertip.

In the display control apparatus according to the present embodiment, the predetermined range includes a plurality of predetermined ranges, different vibrational states are set for the respective predetermined ranges, and the operation surface is vibrated in a predetermined one of the vibrational states set for the respective predetermined ranges when the slide operation reaches an inside of one of the predetermined ranges.

With this configuration, it is possible for a user to intuitively perceive, by a difference in tactual sensation, a difference of an object set as a target of a selection operation, e.g., a difference of an icon set as a target of selection by placing a cursor thereon.

In the display control apparatus according to the present embodiment, if the slide operation is an operation of moving a cursor as the object, the cursor is displayed at a predetermined position when the slide operation reaches the inside of the predetermined range.

With this configuration, it is possible to give, to a user, the sensation that the cursor is drawn into a position of an icon or the like to be set as a target of selection.

A display control apparatus according to the present embodiment controls the piezoelectric drive circuit 2c to vibrate the operation surface 2a in a predetermined vibrational state in the case of a slide operation from an inside of a predetermined range defined on a display surface to an outside of the predetermined range.

With this configuration, it is possible to suggest, through a change in tactual sensation, to a user that an operation position has come out of the predetermined range such that the user can clearly perceive the fact.

In the display control apparatus according to the present embodiment, the predetermined range includes a plurality of predetermined ranges, different vibrational states are set for the respective predetermined ranges, and the operation surface is vibrated in a predetermined one of the vibrational states set for the respective predetermined ranges when the slide operation reaches an outside of one of the predetermined ranges.

With this configuration, it is possible for a user to intuitively perceive, by a difference in tactual sensation, a difference of an object set as a target of a selection operation, e.g., a difference of an icon set as a target of selection by placing a cursor thereon.

In the display control apparatus according to the present embodiment, if the slide operation is an operation of moving a cursor as the object, an operation performed for the operation surface within a predetermined time after the vibration is started is nullified.

With this configuration, vibration of the operation surface 2a makes a finger slip easily. The cursor 53 is prevented from moving excessively even if the finger makes a big movement.

In the display control apparatus according to the present embodiment, the vibration control unit 102 restores a vibrational state of the operation surface to a state before the operation surface is put in the predetermined vibrational state, after a predetermined time from when the vibration of the operation surface in the predetermined vibrational state is started in accordance with the slide operation.

With this configuration, after a finger performing a slide operation of the operation surface 2a slips for a moment, the finger stops. It is thus possible for a user to clearly perceive an operation condition.

### Second Embodiment

In the first embodiment, a detection unit (the touch-pad 2) is provided separately from a display unit (the HUD 120). A detection unit may be provided while being placed on the display unit. A second embodiment illustrates an example where a display 202 that displays display information provided from an AVN machine 100 is used as a display unit and a touch panel 20 (FIG. 1) that is arranged to be placed on the display 202 is used as a detection unit. Like the touch-pad in FIGS. 1 and 3, piezoelectric elements 2b and a piezoelectric drive circuit 2c are provided at the touch panel 20. The other components are the same as those in the first embodiment, same components are denoted by same reference numerals, and a repetitive description thereof will be omitted.

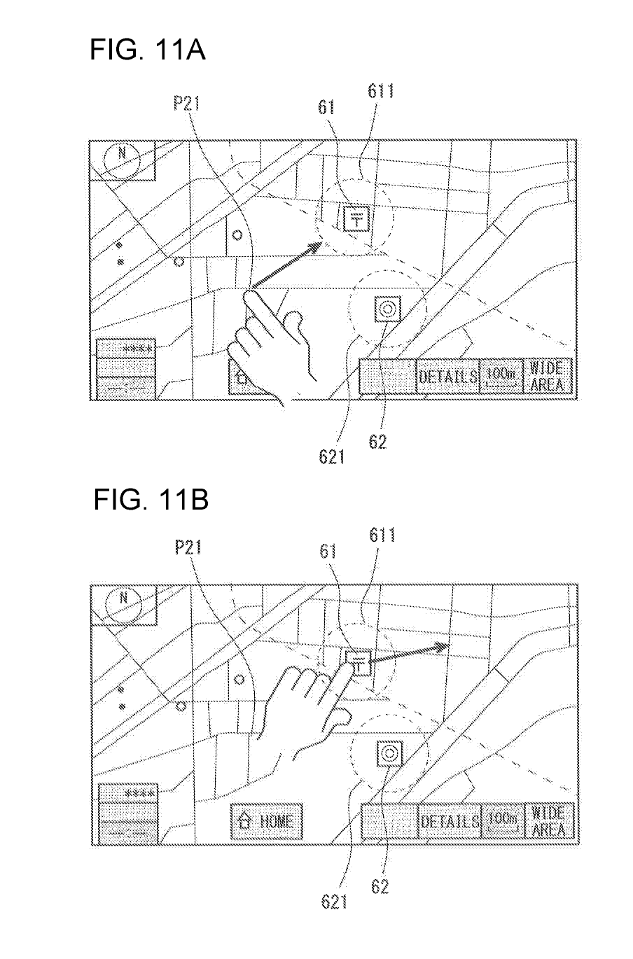

FIGS. 11A and 11B are views each illustrating an example where objects as targets of operation are displayed on the display (display unit) 202. As illustrated in, for example, FIGS. 5A to 5C, a display control apparatus 10 according to the second embodiment displays a plurality of icons 61 and 62 as objects as targets of operation on a display surface of a HUD 120. Predetermined ranges 611 and 621 are defined at positions including the icons 61 and 62. The predetermined ranges 611 and 621 extend from centers of the icons 61 and 62 over a predetermined distance. When an operation positions reaches the inside of the predetermined range 611 or 621, the icon 61 or 62 is regarded as being pointed to (being set as a target of selection).

If a user touches an operation surface (display surface) of the display 202 and performs an operation for the icon 61 or 62, the touch panel 20 detects a contact position. Since the touch panel 20 is placed on the display 202 in the second embodiment, coordinates of the contact position detected by the touch panel 20 correspond directly to a display position (operation position) on the display 202.

If the user performs a slide operation from an arbitrary position P21, such as an intersection, toward the icon 61, as illustrated in FIG. 11A, when the contact position (operation position) reaches the inside of the predetermined range 611, the display control apparatus 10 controls the piezoelectric drive circuit 2c to drive the piezoelectric elements 2b included in the touch panel 20 and vibrates an operation surface of the touch panel 20 in a predetermined vibrational state. After a predetermined time (e.g., 0.1 s), the display control apparatus 10 stops the vibration. This reduces a sensation of resistance of a finger performing the slide operation on the operation surface of the touch panel 20 for a moment, slips the finger, restores the sensation of resistance, and stops the finger.

With this configuration, it is possible to give, to the user, the sensation that the finger is drawn into the icon 61.

If the user performs a slide operation from the inside of the predetermined range 611 toward the outside, as illustrated in FIG. 11B, when the contact position (operation position) reaches the outside of the predetermined range 611, the display control apparatus 10 controls the piezoelectric drive circuit 2c to vibrate the operation surface of the touch panel 20 in a predetermined vibrational state. After a predetermined time (e.g., 0.1 s), the display control apparatus 10 stops the vibration. This reduces a sensation of resistance of the finger performing the slide operation on the operation surface of the touch-pad 2 for a moment, slips the finger, restores the sensation of resistance, and stops the finger.

With this configuration, the sensation that the finger has come out of the icon 61 is given to the user. The user can clearly perceive that the contact position (operation position) has come out of the icon 61.

The embodiments of the present invention have been described above. The embodiments are merely illustrative, and the present invention is not limited to these. Various changes may be made on the basis of the knowledge of those skilled in the art without departing from Scope of Claims.

1. A display control apparatus for displaying an object as a target of operation on a display surface of a display unit and accepting a user operation for an operation surface associated with the display surface, comprising:
a display control unit that causes the display unit to display the object;
an operation acceptance unit that accepts an operation for the object on the display surface on the basis of a detection result from a detection unit that detects contact with the operation surface; and
a vibration control unit that controls a vibration unit that vibrates the operation surface if the operation accepted by the operation acceptance unit is a slide operation from an outside of a predetermined range defined on the display surface to an inside of the predetermined range and vibrates the operation surface in a predetermined vibrational state when the slide operation reaches the inside of the predetermined range.

2. The display control apparatus according to claim 1, wherein the predetermined range comprises a plurality of predetermined ranges, different vibrational states are set for the respective predetermined ranges, and the operation surface is vibrated in a predetermined one of the vibrational states set for the respective predetermined ranges when the slide operation reaches an inside of one of the predetermined ranges.

3. The display control apparatus according to claim 1, wherein if the slide operation is an operation of moving a cursor as the object, the cursor is displayed at a predetermined position when the slide operation reaches the inside of the predetermined range.

4. A display control apparatus for displaying an object as a target of operation on a display surface of a display unit and accepting a user operation for an operation surface associated with the display surface, comprising:
a display control unit that causes the display unit to display the object;
an operation acceptance unit that accepts an operation for the object on the display surface on the basis of a detection result from a detection unit that detects contact with the operation surface; and
a vibration control unit that controls a vibration unit that vibrates the operation surface if the operation accepted by the operation acceptance unit is a slide operation from an inside of a predetermined range defined on the display surface to an outside of the predetermined range and vibrates the operation surface in a predetermined vibrational state when the slide operation reaches the outside of the predetermined range.

5. The display control apparatus according to claim 4, wherein the predetermined range comprises a plurality of predetermined ranges, different vibrational states are set for the respective predetermined ranges, and the operation surface is vibrated in a predetermined one of the vibrational states set for the respective predetermined ranges when the slide operation reaches an outside of one of the predetermined ranges.

6. The display control apparatus according to claim 4, wherein if the slide operation is an operation of moving a cursor as the object, an operation performed on the operation surface within a predetermined time after the vibration is started is nullified.

7. The display control apparatus according to claim 1, wherein the vibration control unit restores a vibrational state of the operation surface to a state before the operation surface is put in the predetermined vibrational state, after a predetermined time from when the vibration of the operation surface in the predetermined vibrational state is started in accordance with the slide operation.

8. The display control apparatus according to claim 1, wherein the detection unit is a touch-pad provided separately from the display unit or a touch panel provided to be placed on the display surface of the display unit.

9. A display control system comprising:
a display unit that displays an object as a target of operation;
a display control unit that causes the display unit to display the object;
a detection unit that detects contact with an operation surface;
an operation acceptance unit that accepts an operation for the object on a display surface on the basis of a detection result from the detection unit;
a vibration unit that vibrates the operation surface; and
a vibration control unit that controls the vibration unit if the operation accepted by the operation acceptance unit is a slide operation from an outside of a predetermined range defined on the display surface to an inside of the predetermined range and vibrates the operation surface in a predetermined vibrational state when the slide operation reaches the inside of the predetermined range.

10. A display control system comprising:
a display unit that displays an object as a target of operation;
a display control unit that causes the display unit to display the object;
a detection unit that detects contact with the operation surface;
an operation acceptance unit that accepts an operation for the object on a display surface on the basis of a detection result from the detection unit;
a vibration unit that vibrates the operation surface; and
a vibration control unit that controls the vibration unit if the operation accepted by the operation acceptance unit is a slide operation from an inside of a predetermined range defined on the display surface to an outside of the predetermined range and vibrates the operation surface in a predetermined vibrational state when the slide operation reaches the outside of the predetermined range.

11. A display control method for causing a computer controlling equipment that displays an object as a target of operation on a display surface of a display unit and accepts a user operation for an operation surface associated with the display surface to execute:
causing the display unit to display the object;
accepting an operation for the object on the display surface on the basis of a detection result from a detection unit that detects contact with the operation surface; and
controlling a vibration unit that vibrates the operation surface if the operation accepted in the accepting is a slide operation from an outside of a predetermined range defined on the display surface to an inside of the predetermined range and vibrating the operation surface in a predetermined vibrational state when the slide operation reaches the inside of the predetermined range.

12. A display control method for causing a computer controlling equipment that displays an object as a target of operation on a display surface of a display unit and accepts a user operation for an operation surface associated with the display surface to execute:
causing the display unit to display the object;
accepting an operation for the object on the display surface on the basis of a detection result from a detection unit that detects contact with the operation surface; and
controlling a vibration unit that vibrates the operation surface if the operation accepted in the accepting is a slide operation from an inside of a predetermined range defined on the display surface to an outside of the predetermined range and vibrating the operation surface in a predetermined vibrational state when the slide operation reaches the outside of the predetermined range.
